(19) United States
(12) Patent Application Publication
(10) Pub. No.: US 2010/0128431 A1
(43) Pub. Date: May 27, 2010

(54) HYBRID LIQUID-AIR COOLED GRAPHICS DISPLAY ADAPTER

(76) Inventors: Andre Sloth Eriksen, Aalborg (DK); Flemming Ferlov Nielsen, Pandrup (DK)

Correspondence Address: Polster, Lieder, Woodruff & Lucchesi, L.C., 12412 Powerscourt Dr. Suite 200, St. Louis, MO, 63131-3615, US

(21) Appl. No.: 12/529,995

(22) PCT Filed: Mar. 7, 2008
(86) PCT No.: PCT/US08/56167

§ 371 Date: Jan. 25, 2010

Related U.S. Application Data
(60) Provisional application No. 60/893,434, filed on Mar. 7, 2007.

(51) Int. Cl. G06F 1/20; B23P 15/26

(52) U.S. Cl. 361/679.47; 29/890.035

(57) ABSTRACT

A hybrid liquid-air cooling system which may be easily adapted to provide a liquid cooling mechanism for use with a wide range of heat sources on components or adapter boards (10) in a personal computer system, and which functions cooperatively with an air cooling system (106). The liquid cooling mechanism includes a cold plate component (100) adapted for use with a wide range of applications, and Is secured in place by an exchangeable mounting clip (104) which eliminates the need to breach the liquid cooling system flow pathways (102) to insert, remove, or replace heat source components. The cold plate component (100) functions cooperatively with an air cooling structure (106) consisting generally of an aluminum heat sink, cooling fins (106a), heat pipes (106b), and a cooling fan (106c).

### CROSS-REFERENCE TO RELATED APPLICATIONS

The present application is related to, and claims priority from, U.S. Provisional Patent Application Ser. No. 60/893,434 filed on Mar. 7, 2007, and which is herein incorporated by reference.

### BACKGROUND OF THE INVENTION

The present invention is related generally to a system for cooling component circuit boards, electronic components, and heat sources associated with electronic components, and is directed specifically to a hybrid liquid-air cooling system adapted for use in cooling integrated circuit components such as those found in a personal computer system.

Personal computer systems which are designed for desktop or under-desk use, and which are typically characterized by a main-board or motherboard housed in a chassis or case. These auxiliary components may include network adapter circuit boards, modems, specialized adapters, and graphics display adapters. These auxiliary components may receive power through the connection to the motherboard, or through additional connections directly to a system power supply contained within the chassis or case. Additional components which generate heat, such as hard drives, disk drives, media readers, etc. may further be contained within the chassis or case, and coupled to the system power supply and motherboard as needed.

During operation, the motherboard and various auxiliary components consume power and generate heat. To ensure proper functionality of the computer system, it is necessary to regulate the operating temperatures inside the environment of the chassis or case. Individual integrated circuits, especially memory modules and processors, may generate significant amounts of heat during operation, resulting in localized hot spots within the chassis environment. The term “processors”, as used herein, and as understood by one of ordinary skill in the art, describes a wide range of components, which may include dedicated graphics processing units, microprocessors, microcontrollers, digital signal processors, and general system processors such as those manufactured and sold by Intel and AMD. Failure to maintain adequate temperature control throughout the chassis environment, and at individual integrated circuits, can significantly degrade the system performance and may eventually lead to component failure.

Traditionally, a cooling fan is often associated with the system power supply, to circulate air throughout the chassis environment, and to exchange the high temperature internal air with cooler external air. However, as personal computer systems include increasing numbers of individual components and integrated circuits, and applications become more demanding on additional processing components such as graphics display adapters, a system power supply cooling fan may be inadequate to maintain the necessary operating temperatures within the chassis environment.

Specialized liquid cooling systems are available for some components in a personal computer system. Specialized liquid cooling systems typically required a coolant circulation pathway, which routes a thermal transfer liquid between a heat exchanger such as a radiator and a heat source, such as a CPU, GPU, microprocessor or transformer. Specialized liquid cooling systems are well adapted for maintaining adequate operating temperatures for individual components. However, these specialized liquid cooling systems are not easily adapted for use with a wide variety of components or adapter boards in a personal computer system. Furthermore, once such liquid cooling systems are installed, it is difficult to replace, insert, or remove components requiring cooling from the system, as the liquid cooling system must either be drained or breached to facilitate the replacement, insertion, or removal.

Accordingly, it would be advantageous to provide a hybrid liquid-air cooling system which may be easily adapted to provide a liquid cooling mechanism for use with a wide range of components in a personal computer system, and which functions cooperatively with an air cooling system. It would be further advantageous to provide a liquid-air cooling system which may be easily detached from an associated heat source without draining of any liquid coolant or breaching of the coolant flow pathways, enabling replacement, addition, or removal of heat source components such as upgraded processors.

### BRIEF SUMMARY OF THE INVENTION

Briefly stated, the present disclosure provides a hybrid liquid-air cooling system which may be easily adapted to provide a liquid cooling mechanism for use with a wide range of components in a personal computer system, and which functions cooperatively with an air cooling system. The liquid cooling mechanism includes a cold plate component adapted for use with a wide range of applications, such as different types of integrated circuits or processors, and which is removably secured in place in proximity to the heat source by an exchangeable mounting clip. The cold plate component may optionally be configured to function cooperatively with an air cooling structure consisting generally of an aluminum heat sink, cooling fins, heat pipes, and a cooling fan. A shroud or duct surrounds the cold plate component and the air cooling structure, facilitating a flow of air across a thermal gradient from hot to cold.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective external view of a hybrid liquid-air cooled graphics display adapter of the present invention;

FIG. 2 is a perspective view of the hybrid liquid-air cooled graphics display adapter of FIG. 1, with the external components shown in phantom;

FIG. 3 is a view similar to FIG. 2, but from a different orientation;

FIG. 4 is a view of a cold plate component of the present invention installed on a graphics display adapter;

FIG. 5 is an underside perspective view of the cold plate component of FIG. 4, installed over a graphics processor which is shown in phantom;

FIG. 6A is a topside perspective view of the cold plate component of FIG. 4;

FIG. 6B is a sectional view of an attachment point for the cold plate component of FIGS. 5 and 6A;

FIG. 7 is a perspective view of an embodiment of a liquid manifold of the present invention;

FIG. 8 is a perspective view of an alternate embodiment of a liquid manifold of the present invention;

FIGS. 9A through 9D illustrate the placement of an exchangeable mounting clip over a liquid manifold of the present invention for attachment to an adapter board;

FIG. 10 is a perspective view of a liquid cooling system of the present invention operatively coupled to a coolant fluid loop and heat exchanger; and

FIG. 11 is a perspective view of a liquid cooling system of the present invention having components coupled in a chain configuration within the coolant fluid loop.

Corresponding reference numerals indicate corresponding parts throughout the several figures of the drawings. It is to be understood that the drawings are for illustrating the concepts set forth in the present disclosure and are not to scale.

### DESCRIPTION OF THE PREFERRED EMBODIMENT

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

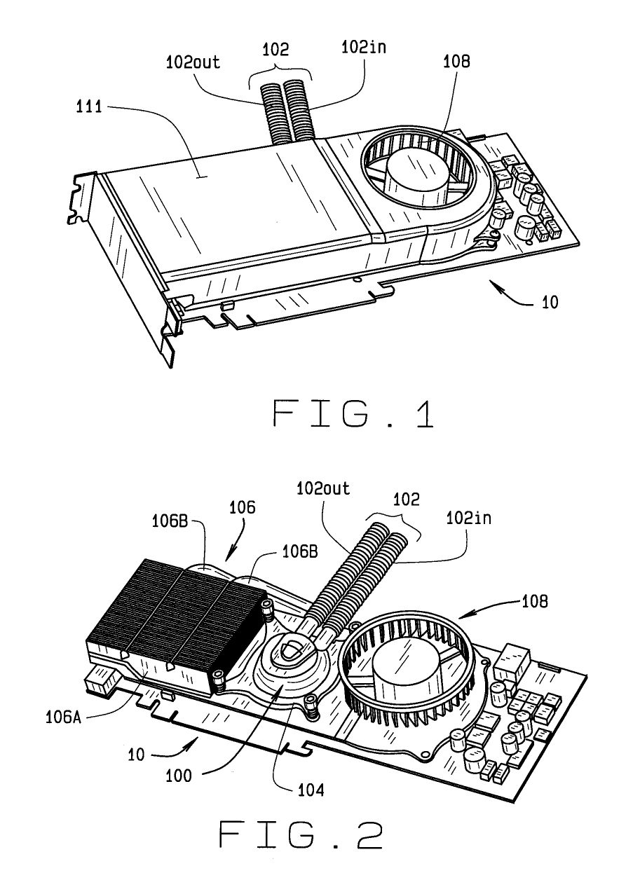

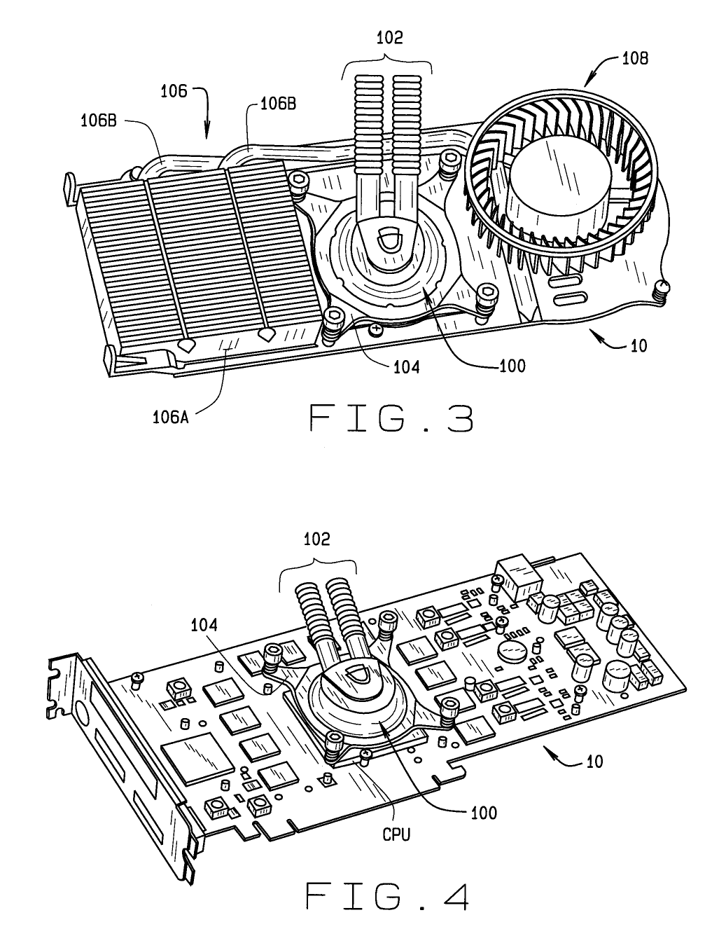

While the present disclosure is described generally in connection with the use of the present invention on a graphics display adapter, those of ordinary skill in the art will readily recognize that the present invention is not limited to use on a graphics display adapter, and may easily be utilized with any of a wide variety of heat sources commonly found in a personal computer system without departing from the scope of the invention. Turning to FIG. 1-4, a cold plate 100 of the present invention is shown secured over a video or graphic processing unit of a graphics display adapter 10. The cold plate 100 is shown configured for connection to an existing liquid cooling loop 102 via any suitable liquid pathway. Preferably the liquid cooling loop 102, which is not directly part of the present invention, provides all necessary components for circulating a flow of liquid coolant to and from the cold plate 100, thereby drawing heat away from the various heat-generating components in proximity to the cold plate 100.

Preferably, the cold plate 100 is made from a material which facilitates a transfer of heat, such as a metal like copper or aluminum, or an alloy. The cold plate 100 is of a generic design and may be operatively secured in contact with different types of heat sources such as processors, power supplies, or graphic display cards by utilizing an exchangeable mounting clip 104 associated with the selected heat source. The cold plate 100 may be mounted as a member of a larger heat conducting structure 106 best seen in FIGS. 1-3. The heat conducting structure 106 may be made from any suitable material, such as aluminum or copper, and preferably contacts each hot spot or component on the graphics display card 10 on one or more sides (with exception of the video or graphics processing unit, as the cold plate 100 is cooling this) to act as a heat sink. Optionally, thermal energy may be further drawn out of the aluminum structure by air convection across cooling fins 106A, heat pipes 106B, and a fan 108. Everything is preferably enclosed within a duct or shroud 110 that will ensure that the heated air is blown out of the personal computer case or otherwise routed away from the graphics display adapter.

Optionally, the cold plate 100 itself may incorporate external cooling fins to facilitate cooling by the air stream in addition to the cooling by the flow of cooling liquid from the liquid cooling loop 102. The inclusion of external cooling fins on the cold plate 100 is particularly advantageous for situations where the liquid cooling loop 102 has reached a thermal capacity, thereby enabling off loading of additional thermal input by air cooling.

By separating the cold plate 100 for cooling the video or graphics processing unit from the rest of the cooling system, it is possible to design a generic cold plate 100 that can be utilized to fit over multiple styles and configurations of video and graphics processing units, meaning that the manufacturer of the graphics display adapter 10 does not have to carry a large number of different cold plate products, but can do with one generic liquid cooling solution merely exchange the aluminum parts and/or the mounting clips 104 as required for different applications. Furthermore, when a component being cooled by an associated cold plate 100 is to be removed, replaced, or added, the generic design of the cold plate 100 and exchangeable mounting clip 104 enables the cold plate 100 to be disconnected from the component without requiring any draining or breaching of the liquid coolant circulation pathways, allowing the component to be replaced, added, or removed without difficulty.

An additional benefit of utilizing a liquid-air hybrid cooling system of the present invention is that the form factors of the various other cooling components 106, such as the aluminum cooling structure, may be made smaller when compared to an all-air cooled solution, due to the fact that the air cooling components do not have to cool the highest heat outputting component, i.e. the video or graphics processing unit, which is now cooled by the liquid cooling loop 102 through contact with the cold plate 100.

This invention is basically different in the sense that it is considered as a single cooling system, but is based on a combination of different technologies. As mentioned before the cold plate 100 is configured as a generic component to cooperatively function with the air cooled components 106, which may vary according to the configuration or design of the graphics display adapter or component board 10.

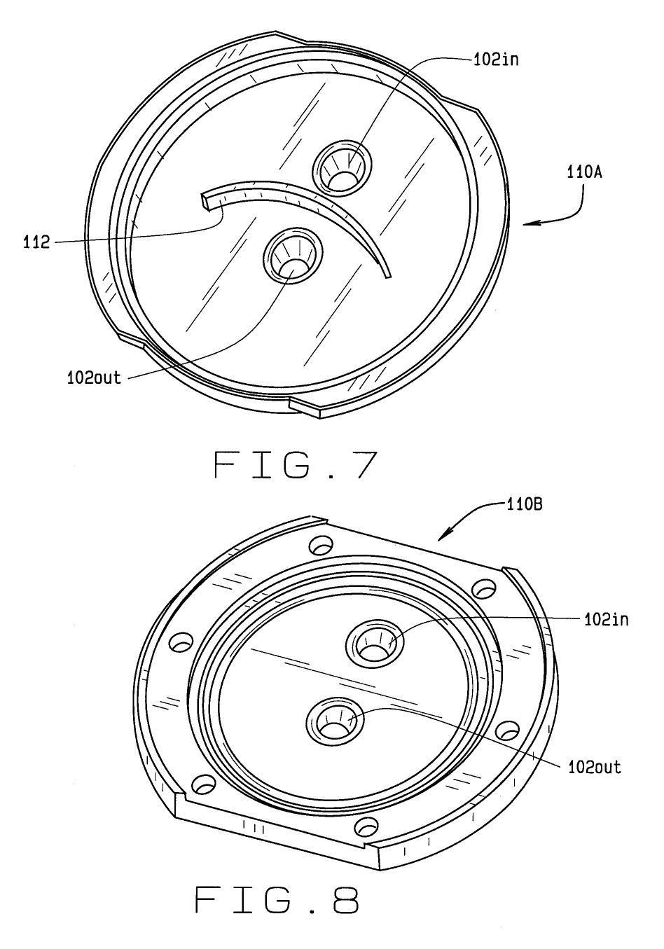

As shown in FIGS. 7 and 8, the specific configuration of the cold plate fluid manifold 110A, or 1108, which is coupled to an upper surface of the cold plate 100 to form an enclosed chamber in the liquid cooling loop 102 to facilitate circulation of the cooling liquid throughout the coolant flow circuit between a fluid delivery 102ᵢₙ and fluid return line 102ₒᵤₜ, may be varied as required. For example, as shown in FIG. 7, a fluid flow diverter 112 is disposed between the cooling liquid input 102ᵢₙ and output 102ₒᵤₜ ports in the cold plate fluid manifold 110A. When the cold plate fluid manifold 110A is disposed over the surface of the cold plate 100 which, in turn is in contact with the upper surface of a video or graphics processing unit, the fluid circulation chamber is formed within which cooling fluid may circulate to draw heat from the surrounding surfaces, particularly heat conveyed from the heat source by the cold plate 100. During use, cooling liquid flows into the cold plate fluid manifold 110A through the liquid input port 102ᵢₙ, and must circulate around the fluid flow diverter 112 before existing the fluid manifold 110A through the liquid output port 102ₒᵤₜ. The flow of fluid ensures a uniform cooling of the various surfaces in contact with the cold plate 100, such as a video or graphics processing unit. The fluid flow diverter 112 may take many forms, including a multitude of pins and/or fins, and may be formed either on the cold plate fluid manifold as at 110A, or on the surface of the cold plate 100 which is exposed to the fluid chamber. Alternatively, as shown in FIG. 8, the fluid flow diverter 112 may be eliminated, and fluid allowed to flow freely within the fluid circulation chamber between the cold plate 100 and the fluid manifold as at 110B.

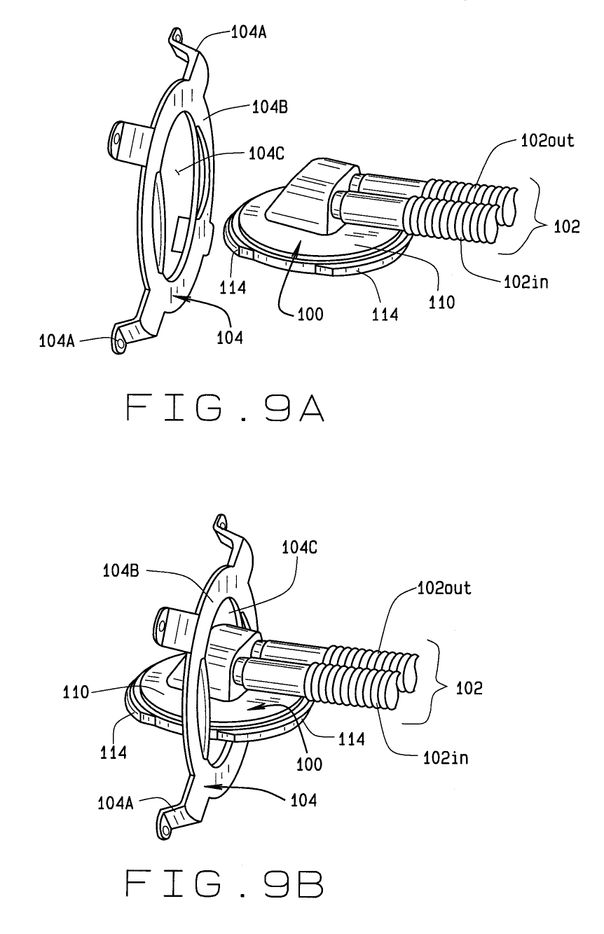

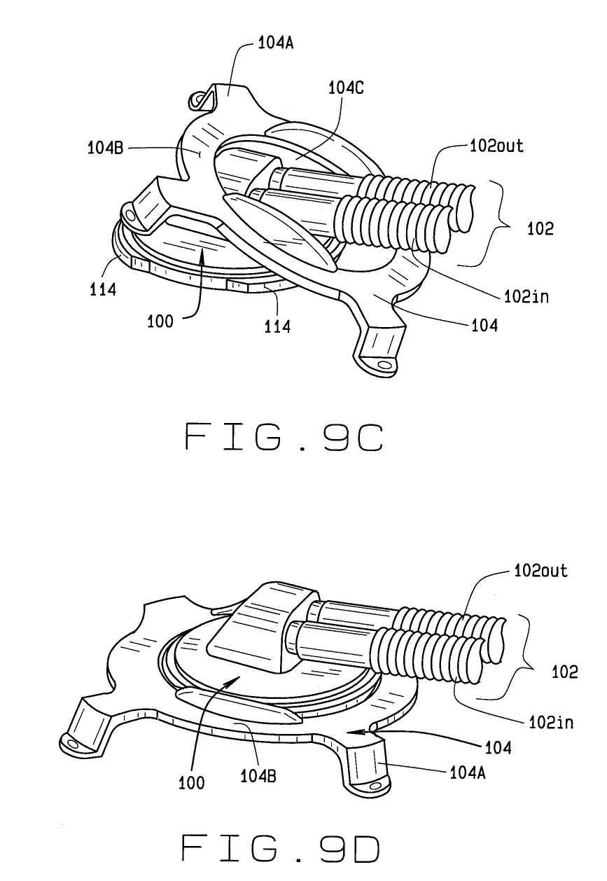

To secure the cold plate 100 in place over a video or graphics processing unit, a variety of different attachment means may be utilized. FIGS. 9A-9D illustrate the use of an interchangeable attachment bracket or mounting clip 104 to secure the cold plate 100, together with the coupled fluid manifold 110A, 110B in place on an adapter board. The interchangeable attachment bracket 104 is designed with a set of mounting tabs 104A and a central portion 104B having an opening 104C sized to slip-fit over the cold plate 100 and fluid manifold 110, as shown in FIGS. 9A and 9B. Once in place over the cold plate 100 and fluid manifold 110, the attachment bracket 104 is rotated into a co-planar configuration with the cold plate 100 and fluid manifold 110, as shown in FIGS. 9C and 9D, preferably engaging a set of opposing flanges 114 on the peripheral edges of the cold plate 100. The attachment bracket 104 includes a set of tabs 104A through which screws, bolts, or clips may be installed to secure the attachment bracket 104 and the cold plate 100/fluid manifold 110 in place against an electronic component to be cooled.

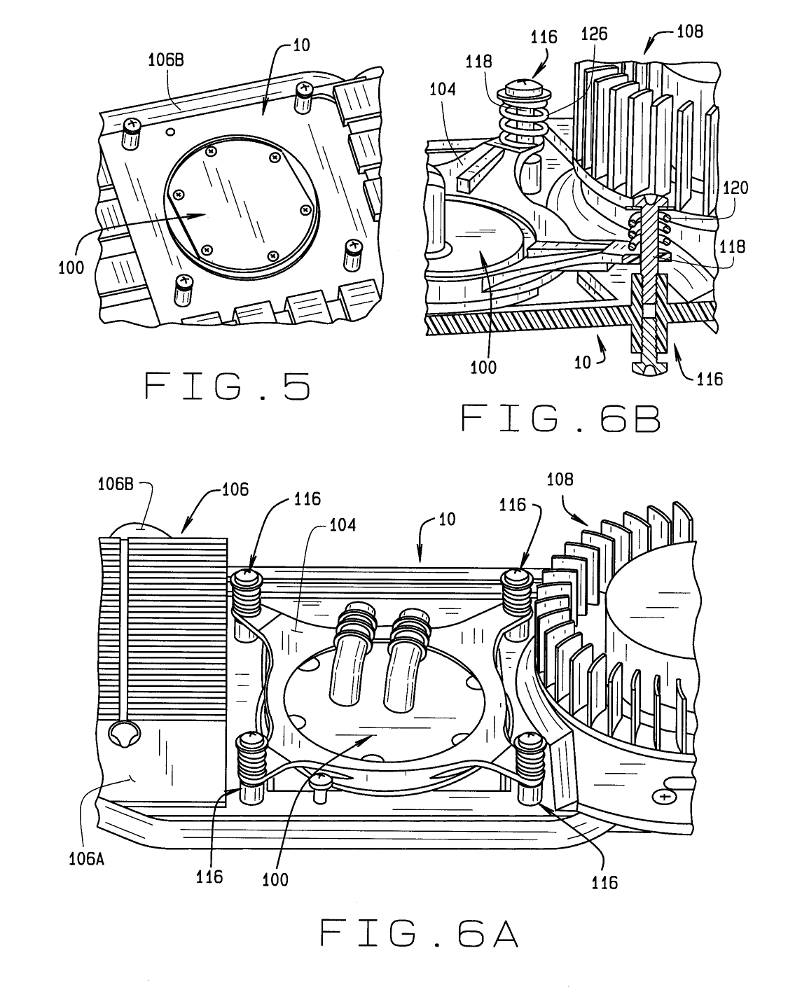

For example, as shown in FIGS. 5 and 6A-6B, the cold plate 100 may be secured in place over the heat source with a spring bias retention system 116, wherein threaded connectors 118 are utilized to hold attachment springs 120 in place against the tabs 104A on the attachment bracket 104. The springs 120 provide a bias force holding the cold plate 100 against the surface of the heat sink. Those of ordinary skill in the art will recognize that the specific configuration of the tabs 104A on the attachment bracket 104 may be varied in position, size, and number, as required for specific applications, and that the attachment means may be spring biased or secured by any other suitable method of affixation. Accordingly, it will be further understood that by providing a number of different attachment brackets 104, a single cold plate design 100 may be readily used in a wide range of attachment applications without requiring custom designs.

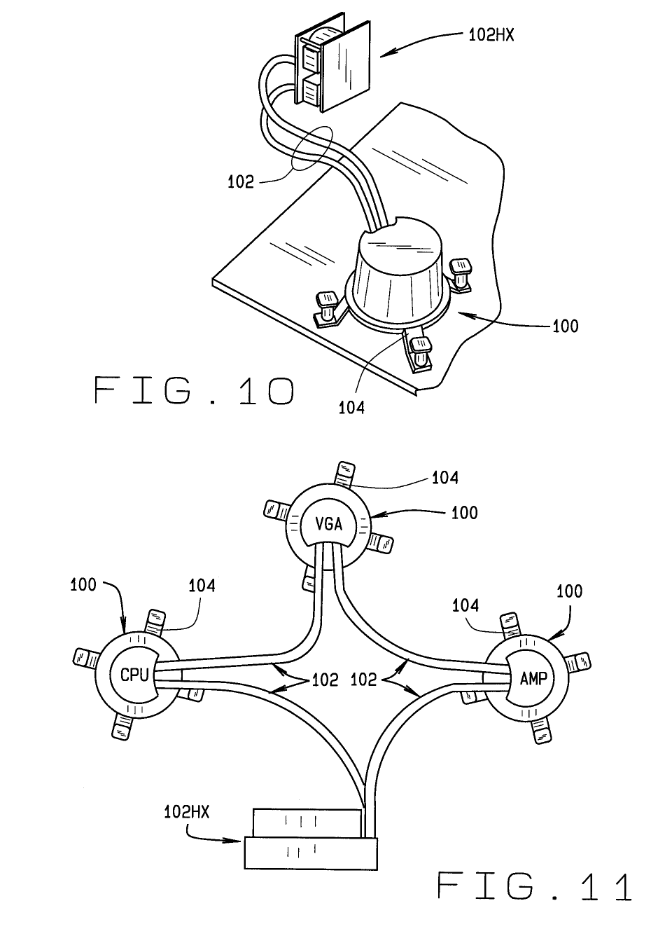

For example, as shown in FIG. 10, a single cold plate 100 and fluid manifold 110 may be secured in place over a heat source such as a main-board processing unit, or one or more graphics processing units in parallel or series, and coupled to coolant fluid loop 102 and heat exchanger 102Hx. Alternatively, a set of cold plates 100 may be secured in place over a main-board processing unit, a graphics processing unit, and an audio processing unit, and then each may be coupled in series to a coolant fluid loop 102 and heat exchanger 102Hx to enable cooling of multiple components in a system utilizing the cold plates 100 of the present invention. The use of an adaptable attachment bracket 104 for securing the cold plates 100 in place over a variety of components enables an end-user to utilize the cooling system of the present invention in a flexible manner to provide cooling to one or more heat sources, and to expand or contract the size of the system as necessary to accommodate the addition or removal of components.

As various changes could be made in the above constructions without departing from the scope of the disclosure, it is intended that all matter contained in the above description or shown in the accompanying drawings shall be interpreted as illustrative and not in a limiting sense.

1. A hybrid liquid-air cooling system adapted to provide a combination of a liquid cooling mechanism and an air cooling mechanism for use with a heat source component in a personal computer system, comprising:
a cold plate component adapted to receive thermal energy through a cold plate from a proximally located heat source of the heat source component, said cold plate component including a fluid manifold linked to a liquid coolant circulation pathway of a liquid cooling system for directing a flow of cooling liquid through a fluid chamber enclosed between said cold plate and said fluid manifold;
an interchangeable attachment bracket for removably securing said cold plate component with said cold plate in proximity to said heat source, whereby thermal energy from the heat source is transferred to the flow of cooling liquid within said fluid chamber via said cold plate; and
a discrete air cooling structure secured to said heat source component in proximity to said cold plate component and to one or more secondary heat sources on the heat source component, said air cooling structure including a radiator structure configured to transfer thermal energy from said one or more secondary heat sources to a flow of air, and wherein said air cooling structure configured to operate in conjunction with said cold plate component to transfer thermal energy from said heat source component.

2. The hybrid liquid-air cooling system of claim 1 wherein said air cooling structure includes a heat sink configured to absorb thermal energy from said one or more secondary heat source components.

3. The hybrid liquid-air cooling system of claim 1 wherein said radiator structure includes a plurality of cooling fins configured to transfer thermal energy from said one or more secondary heat source components into said flow of air.

4. The hybrid liquid-air cooling system of claim 1 wherein said air cooling structure includes a cooling fan configured to direct said flow of air across at least one surface of said radiator structure.

5. The hybrid liquid-air cooling system of claim 1 further including a shroud or duct surrounding said cold plate component and the air cooling structure, facilitating said flow of air across a thermal gradient in proximity to said radiator structure and said cold plate component.

6. The hybrid liquid-air cooling system of claim 1 wherein said heat source is a processing unit and wherein said one or more secondary heat sources include integrated circuits operatively coupled to said processing unit.

7. The hybrid liquid-air cooling system of claim 1 wherein said fluid manifold includes at least one cooling fluid input port and at least one cooling fluid output port operatively coupled to said fluid chamber.

8. The hybrid liquid-air cooling system of claim 5 including at least one fluid circulation diverter within said fluid chamber.

9. The hybrid liquid-air cooling system of claim 1 wherein said cold plate component includes at least one radiator component operatively coupled to said cold plate and disposed within said flow of cooling liquid contained within said fluid chamber, said at least one radiator component configured to transfer thermal energy from said heat source to said flow of cooling liquid within said fluid chamber.

10. The hybrid liquid-air cooling system of claim 1 wherein said interchangeable attachment bracket is configured to facilitate coupling and decoupling of said cold plate component in proximity to said heat source without breaching said fluid manifold and said coolant circulation pathway.

11. The hybrid liquid-air cooling system of claim 1 wherein said interchangeable attachment bracket holds said cold plate in proximity to said heat source with a spring bias.

12. The hybrid liquid-air cooling system of claim 1 wherein said radiator structure includes a heat pipe, configured to convey thermal energy away from said secondary heat sources for exchange to said flow of air.

13. The hybrid liquid-air cooling system of claim 1 wherein said air cooling structure is at least partially enclosed within an air-flow directing shroud structure.

14. The hybrid liquid-air cooling system of claim 1 wherein said heat source component is a graphics display adapter card, and where said heat source includes a graphics processing unit disposed on said graphics display adapter card.

15. The hybrid liquid-air cooling system of claim 5 wherein said cold plate component further includes a plurality of external thermal radiators configured to operate in conjunction with said discrete air cooling structure to transfer thermal energy from said cold plate component to said flow of air.

16. A method for cooling a personal computer systems adapter card having a processing unit heat source and a plurality of secondary integrated circuit heat sources, in a personal computer system having an integrated liquid cooling system defined by at least one cold plate assembly coupled by a liquid coolant circulation pathway to a remote heat exchanger, comprising:
coupling an air cooling structure to said adapter card in proximity to said plurality of secondary integrated circuit heat sources;
selecting an attachment bracket based on a configuration of said at least on cold plate assembly and on a configuration of said adapter card;
mounting said selected attachment bracket to said adapter card in proximity to said processing unit heat source;
removably seating said cold plate component within said selected attachment bracket;
biasing said cold plate component within said selected attachment bracket against said processing unit heat source; and
transferring thermal energy away from said secondary integrated circuit heat sources on said personal computer system adapter card via a directed flow of air through said air cooling structure and away from said processing unit heat source on said personal computer system adapter card via a circulation of liquid coolant through said cold plate component.

17. The method of claim 16 further including the step of enclosing at least said air cooling structure within a shroud; and directing a flow of air across a thermal gradient within said shroud.
